(19) United States
(12) Patent Application Publication
(10) Pub. No.: US 2004/0084648 A1
(43) Pub. Date: May 6, 2004

(54) Precision controlled fast valve

(75) Inventor: Steven C. Quarre, Woodinville, WA (US)

Correspondence Address: Pillsbury Winthrop LLP, Intellectual Property Group, Suite 200, 11682 El Camino Real, San Diego, CA, 92130-2092, US

(73) Assignee: Applied Precision, LLC

(21) Appl. No.: 10/690,109

(22) Filed: Oct. 20, 2003

Related U.S. Application Data
(63) Continuation of application No. 10/108,803, filed on Mar. 27, 2002, now abandoned.
(60) Provisional application No. 60/280,314, filed on Mar. 29, 2001.

(51) Int. Cl. F16K 31/02

(52) U.S. Cl. 251/129.04; 251/129.17; 251/129.06

(57) ABSTRACT

A precision controlled fast valve includes a diaphragm, a piezo actuator, and a plunger. The plunger is adapted to engage the diaphragm to create a seal which closes the valve. The piezo actuator is attached to the plunger and adapted to receive control signals which define the distance and speed of travel of the plunger. A control signal is received by the piezo actuator which causes the plunger to rapidly travel to a first position which is proximate to the diaphragm but does not create a seal. A second control signal is received by the piezo actuator which causes the plunger to pinch the diaphragm and creates a seal (due to the blocked force generated by the piezo). Creating the seal without excessive forces reduces the wear on the seal, allowing longer intervals between maintenance.

### CROSS-REFERENCE TO RELATED APPLICATIONS

This application claims benefit of U.S. Provisional application No. 60/280,314, filed Mar. 29, 2001, the content of which is herein incorporated by reference in its entirety.

### TECHNICAL FIELD

The invention relates to piezo actuation of fluid valves. More specifically, the invention relates to rapidly and precisely controlling the movement of gas flow valves.

### BACKGROUND

High accuracy, low flow valves are used in a variety of applications. Such applications include high pressure gas chromatography, fractional distillation, and the manufacture of semiconductor wafers. The manufacture of semiconductor wafers presents specific problems in managing gas flow in epitaxal reactors which manufacture today's semiconductor products. As is well known by those of ordinary skill in the art, a silicon wafer for a semiconductor device is built up in layers from a semiconductor wafer substrate, typically manufactured from silicon dioxide. The degree to which the silicon dioxide conducts electricity in the presence of an electrical field is determined by the quantity of “impurities” which are driven into the surface of the substrate. These “impurities” are in fact desirable elements and their presence or absence must be carefully controlled. Furthermore, the circuits which are imbedded in the semiconductor wafer are deposited in layers on top of the substrate. Subsequent etching and redeposition steps, including a final metalization layer results in a complex circuit imbedded in the semiconductor wafer.

All of the above described deposition steps may typically be accomplished by chemical vapor deposition in a high temperature oven better known as an epitaxal reactor. In all cases, the different layers are deposited by vapor deposition from materials in a gaseous state. In order to control the deposition, and to more precisely control the growth of the layers which are built up on the substrate surface the following variables must be carefully controlled: the temperature of the reactor, the flow rate of the selected gas over the substrate, and the time of exposure. It is well known that the degree to which the above steps can be achieved quickly and accurately significantly increases yield thereby reducing the cost of producing a semiconductor product.

The desired size of features on semiconductor wafers is continuously decreasing. The hardware used to manufacture the wafers needs to run faster to achieve the smaller feature size of the wafers, and still provide acceptable throughput of wafer production. With valves, faster operation typically results in increased wear, as the valve seat wears with rapid opening and closing. Increased wear requires more frequent maintenance on the valves, thus decreasing the run time of the manufacturing facilities.

What is desired is a valve that operates at a high enough speed to allow the production of small semiconductor wafers, yet does not exhibit the increased wear that typically accompanies such high speeds.

### SUMMARY

A precision controlled fast valve includes a diaphragm, a piezo actuator, and a plunger. The plunger is adapted to engage the diaphragm to create a seal which closes the valve. The piezo actuator is attached to the plunger and adapted to receive control signals which define the distance and speed of travel of the plunger. A control signal is received by the piezo actuator which causes the plunger to rapidly travel to a first position which is proximate to the diaphragm but does not create a seal, avoiding high impact forces on the diaphragm and/or valve seat. A second control signal is received by the piezo actuator which causes the plunger to clamp the diaphragm and creates a seal. The high forces required for an adequate valve seal are achieved without causing excessive impact loading on the diaphragm/seat. Creating the seal without generating high forces reduces the wear on the seal, allowing longer intervals between maintenance.

### DESCRIPTION OF DRAWINGS

These and other features and advantages of the invention will become more apparent upon reading the following detailed description and upon reference to the accompanying drawings.

FIG. 1 is a perspective view of a gas flow valve according to one embodiment of the invention.

FIG. 2A is a cut-away view of the valve of FIG. 1 showing the valve fully open.

FIG. 2B is valve in first position with a plunger pushing against the diaphragm slightly against the valve seat. A tight seal is not yet formed.

FIG. 3 is a cut-away view of the valve of FIG. 1 showing the valve in a second position with the plunger clamping the diaphragm against the valve seat.

FIG. 4 illustrates a process for controlling the valve according to the present invention.

### DETAILED DESCRIPTION

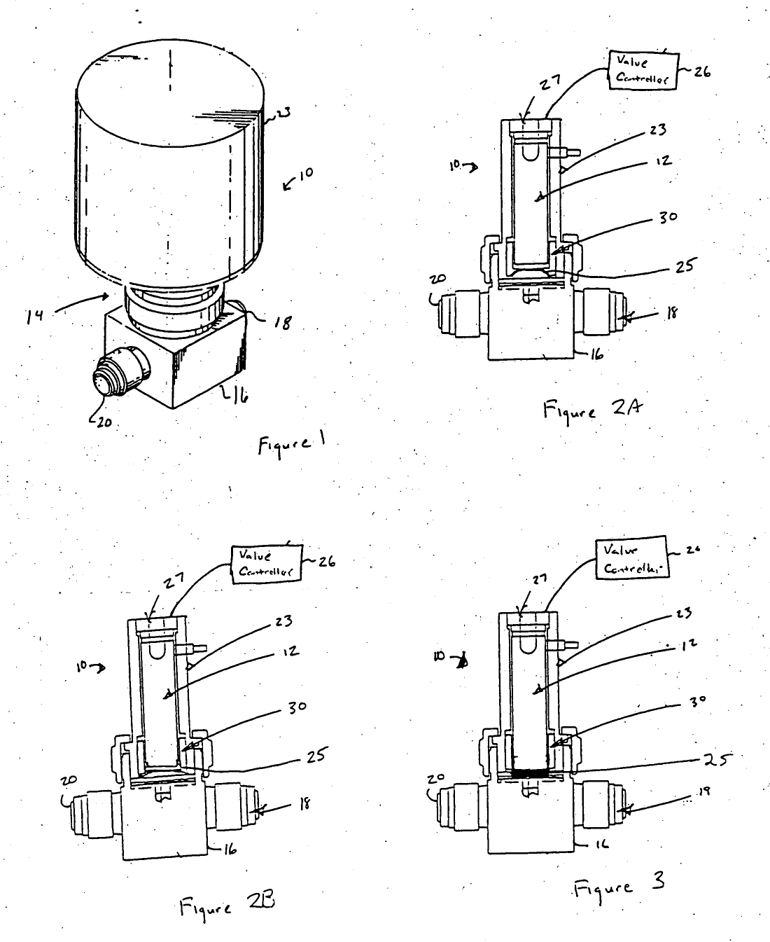

A piezo actuated valve, in accordance with the principals of the invention is generally indicated at reference numeral 10 in FIGS. 1-3. The piezo actuated valve includes a piezo actuator 12, a transmission generally indicated at bracket 14, a valve 16, a bonnet or housing 23, a plunger 30, and a diaphragm 25. The valve 16 may be a diaphragm type low flow, high accuracy valve. The valve 16 has an inlet port 18 and an outlet port 20 with appropriate couplers shown thereon for connecting to hoses or the like of a gas supply and of a gas using equipment, respectively. The gas using equipment can be a variety of equipment including an epitaxal reactor. The present invention enhances the cam actuated valve disclosed in U.S. Pat. No. 5,89,9,437, the contents of which are incorporated herein by reference.

A piezoelectric actuator 12 can produce extremely fine position changes down to the subnanometer range. The smallest changes in operating voltage are converted into smooth movements. Motion is not influenced by stiction/friction or threshold voltages. Fast response is one of the desirable features of the piezo actuator 12. A rapid drive voltage change results in a rapid position change. Acceleration rates of more than 10,000 g's can be obtained. The piezo actuator 12 can reach nominal displacement in approximately ⅓ of the period of the resonant frequency.

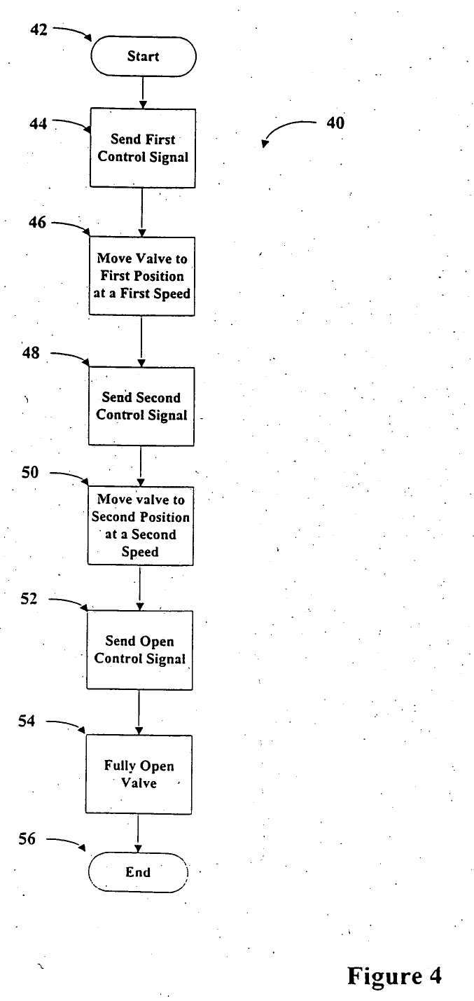

The piezo actuator 12 is bonded to the plunger 30. A valve controller 26 transmits a control signal to the piezo actuator 12 to control the movement of the piezo actuator. The control signal may direct the amount of travel, direction of travel, and speed of travel of the actuator. The process 40 for controlling the valve 10 is shown in FIG. 4. The process 40 begins at a START block 42. Proceeding to block 44, the valve controller 26 transmits a first control signal to the piezo actuator 12. The first control signal contains instructions for movement of the piezo actuator 12.

Proceeding to block 46, the piezo actuator 12 moves in response to the control signal to a first position proximate the diaphragm 25. The first position is illustrated in FIG. 2B, where the plunger 30 is proximate the diaphragm 25 but not quite closing the diaphragm 25 against the valve seat. The piezo actuator 12 moves the plunger to this position at a rapid speed. Because the piezo actuator stops the plunger 30 before the diaphragm 25 is clamped, minimal force is generated against the diaphragm, there is little if any wear on the diaphragm 25 in this step.

Proceeding to block 48, the valve controller 26 transmits a second control signal to the piezo actuator 12. The second control signal contains -further instructions for movement of the piezo actuator 12.

Proceeding to block 50, the piezo actuator 12 moves in response to the second control signal to have the plunger 30 apply pressure on the diaphragm 25 until the diaphragm 25 is displaced to close the valve 16. FIG. 3 illustrates the plunger 30 and diaphragm 25 in the second position to the diaphragm 25 closes the valve 16. The piezo actuator 12 moves the plunger 30 effectively “squeezing” the diaphragm 25 closed. Because the plunger 30 does not have a long distance to travel to reach the second position, the piezo actuator 12 may still maintain a relatively high valve-closing speed overall. Also, by “squeezing” the diaphragm 25 to a closed position, the diaphragm 25 is subjected to much less wear. A high force is generated for sealing the valve because the piezo translates very little during this step, translating on the order of 10 μm. When more voltage is applied to the piezo and the piezo is blocked and cannot translate, a high force is the result—this is known as the “blocked force” generated by the piezo. The blocked force allows for a tight valve seal, but is not an outcome of rapid valve closing. This allows a longer life cycle of the valve 10 before the diaphragm 25 heeds replacing.

Proceeding to block 52, the valve controller 26 transmits an open control signal to the piezo actuator 12. The open control signal contains further instructions for movement of the piezo actuator 12.

Proceeding to block 54, the piezo actuator 12 moves in response to the open control signal to have the plunger 30 retract from the diaphragm 25 to fully open the valve as illustrated in FIG. 2A. The cycle may then be repeated as necessary to open and close the valve 10 rapidly while maintaining low wear on the diaphragm 25. The process 40 the terminates in an END block 56.

A number of embodiments of the invention have been described. Nevertheless, it will be understood that various modifications may be made without departing from the spirit and scope of the invention. Accordingly, other embodiments are within the scope of the following claims.

What is claimed is:

1. A method of closing a valve comprising:
moving the valve to a first position at a first speed, wherein the first position almost closes the valve but does not create an airtight seal; and
moving the valve to a second position which fully closes the valve at a second speed, wherein the first speed is faster than the second speed.

2. The method of claim 1, further comprising applying a first signal to an actuator to cause the movement to the first position.

3. The method of claim 1, further comprising applying a second signal to an actuator to cause the movement to the second position.

4. The method of claim 1, further comprising positioning a valve plunger to touch a valve diaphragm when the valve is in the first position.

5. The method of claim 4, further comprising squeezing the valve diaphragm closed during movement to the second position.

6. The method of claim 1, further comprising applying a signal which causes the valve to fully open.

7. A precision controlled fast valve comprising:
a diaphragm;
a plunger which travels within a bonnet of the valve, wherein the plunger is adapted to engage the diaphragm to create a seal which closes the valve; and
a piezo actuator attached to the plunger, the piezo actuator adapted to receive control signals which define the distance and speed of travel of the plunger.

8. The precision controlled fast valve of claim 7, wherein the plunger travels to a first position at a first speed, wherein the first position positions the plunger proximate to the diaphragm but does not create a seal.

9. The precision controlled fast valve of claim 8, wherein the travel to the first position at the first speed is defined by a first control signal sent to the piezo actuator.

10. The precision controlled fast valve of claim 8, wherein the plunger travels to a second position at a second speed, wherein the second position positions the plunger to engage the diaphragm and create a seal.

11. The precision controlled fast valve of claim 10, wherein the travel to the second position at the second speed is defined by a second control signal sent to the piezo actuator.

12. The precision controlled fast valve of claim 10, wherein the first speed is faster than the second speed.
